(19) United States
(12) Patent Application Publication
(10) Pub. No.: US 2009/0008473 A1
(43) Pub. Date: Jan. 8, 2009

(54) PORTABLE HAZE SPRAYER HAVING MULTI-FUNCTION

(76) Inventor: Jong-Dae Yun, Daegu (KR)

Correspondence Address: LEXYOUME IP GROUP, LLC, 5180 PARKSTONE DRIVE, SUITE 175, CHANTILLY, VA, 20151, US

(21) Appl. No.: 12/025,272

(22) Filed: Feb. 4, 2008

(30) Foreign Application Priority Data
Jul. 2, 2007 (KR) 10-2007-0066211
Jul. 13, 2007 (KR) 20-2007-0011564

(51) Int. Cl. B05B 9/08

(52) U.S. Cl. 239/85; 239/332; 417/223

(57) ABSTRACT

A portable haze sprayer having a multi-function that can spray powder chemicals or a fertilizer, spray chemicals in a high pressure, and widely spray chemicals is provided. The portable haze sprayer includes: a chemical container including a pipe connector for supplying a wind pressure and a supply pipe to be an exit of stored liquid chemicals; an air blower to be driven with an engine; a frame for supporting the chemical container, the engine, and the air blower; an elbow that is communicated to an output terminal of the air blower to supply a wind pressure to the pipe connector of the chemical container through an air supply pipe; a spray pipe that is communicated to the elbow and that hazes chemicals that are supplied from the chemical container; a powder supply pipe that is provided at a side of the elbow to spray a granular fertilizer or powder chemicals to the injection pipe to be opened or closed with a valve with a handle; a pump that is mounted at the center of the frame; a clutch means that is disposed between the air blower and the pump and that interlocks with a clutch lever to switch power; and a level guide for guiding the clutch lever, and a blade assembly that includes a pair of bosses that is disposed to sustain an interval by a bushing within the injection pipe to be rotatably supported a blade.

### CROSS-REFERENCE TO RELATED APPLICATION

This application claims priority to and the benefit of Korean Patent Application No. 10-2007-0066211 & 20-2007-0011564 filed in the Korean Intellectual Property Office on Jul. 2 & 13, 2007, the entire contents of which are incorporated herein by reference.

### BACKGROUND OF THE INVENTION

(a) Field of the Invention

The present invention relates to a portable haze sprayer having a multi-function capable of spraying liquid or solid agrichemicals, fertilizer, and an insect powder with one apparatus.

(b) Description of the Related Art

In order to spray necessary agrichemicals, fertilizer, or insecticide (hereinafter, referred to as “chemicals”) while a farming or a gardening work in a rice paddy, a field, an orchard, and a greenhouse, a sprayer having various structures has been used. A haze sprayer for spraying chemicals in a haze state can obtain a rapid remedial result due to an excellent penetration effect even if a small amount of chemicals is sprayed and a used amount of agrichemicals can be substantially lowered.

FIG. 14 shows a common configuration of a known haze sprayer.

In the shown haze sprayer, a chemical container 4 and an air blower 6 are vertically mounted in a frame 2 having a back and a shoulder strap for carrying on an operator' back and an engine 8 is attached to the center of the backside of the air blower 6.

The air blower 6 is driven by the engine 8 to generate a wind pressure, the generated wind pressure rotates a blade assembly 18 that is provided at the front of an injection pipe 16 while being sent to the injection pipe 16 at the end via an elbow 10, a reducer 12, and an extension pipe 14, and a part of the wind pressure is supplied through a pipe connector 24 of the chemical container 4 via an air supply pipe 20 and an air supply hose 22 that are branched from the elbow 1 0.

A wind pressure that is supplied to the chemical container 4 via the pipe connector 24 increases an air pressure within the chemical container 4 while being changed to a bubble by mixing stored chemicals, thus the chemicals that are changed to a bubble are injected into the injection pipe 16 through a supply pipe 26, a chemical hose 28, and an end pipe 30 that are provided at both ends of the downside, after the chemicals that are injected to a vapor state are hazed by a wind pressure, the chemicals are hazed to a minute particle while passing through the blade assembly 18, and the operator can adjusts a wind pressure of the air blower 6 by decelerating and accelerating the engine 8 with a control lever 32 that is provided in the reducer 12.

Because the haze sprayer having the above-described configuration can spray only liquid chemicals, the haze sprayer has the limitation in a use. That is, the haze sprayer cannot spray powder chemicals or a fertilizer.

Further, the haze sprayer having the above-described configuration sprays chemicals in a particle of 60-80 micrometer, however because the haze sprayer has a structure of sending a part of a wind pressure generating in the air blower to a chemical container and supplying the stored chemicals to an injection pipe, the haze sprayer cannot spray the chemicals in a high pressure. Therefore, when spraying chemicals up to a high location such as a fruit tree or a street tree, the haze sprayer cannot be used.

Further, when the operator carries the haze sprayer on his back and moves, shaking of chemicals is prevented by providing a diaphragm within the chemical container, however because the diaphragm is provided within the chemical container through a mouth thereof, the following problems may be generated.

Because the diaphragm is separately formed from the chemical container, the diaphragm increases a weight of the haze sprayer and is troublesome in an assembling work.

In addition, in order to provide the diaphragm, the mouth of the chemical container should be largely formed and thus a lid thereof should be enlarged, whereby a mold cost that is required for producing the lid increases.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a portable haze sprayer having a multi-function having advantages of hazing and spraying chemicals into ultra-fine particles and spraying powder chemicals or a fertilizer.

The present invention has been made in an effort to provide a portable haze sprayer having a multi-function having advantages of spraying chemicals without difficulty up to a high location using a function of spraying the chemicals in a high pressure.

The present invention has been made in an effort to provide a portable haze sprayer having a multi-function having advantages of having a structure for substantially extending a spraying range of chemicals.

The present invention has been made in an effort to provide a portable haze sprayer having a multi-function having advantages of solving a problem due to separately providing a diaphragm by integrally adding the diaphragm to a chemical container.

The portable haze sprayer according to the present invention has a configuration of mounting a chemical container, an air blower, and an engine at a predetermined position of a frame to which a shoulder strap is attached for an operator to carry on his back and communicating a reducer, an extension pipe, and an injection pipe to an output terminal of the air blower.

In the chemical container, a pipe connector for supplying a wind pressure through an air supply pipe of an elbow and a supply pipe for pushing out stored liquid chemicals with a wind pressure are provided.

Further, a blade assembly for hazing chemicals that are supplied from the chemical container is provided within the injection pipe that is communicated to the elbow.

The elbow further includes a powder supply pipe at one side of the air supply pipe, and a valve is disposed at an internal passage of the powder supply pipe to be opened and closed by an external handle. The powder supply pipe enables powder chemicals that are supplied from a separately provided storage container to flow within the elbow, and the supplied powder chemicals are transferred to the injection pipe along a wind pressure and are sprayed to the surrounding.

Further, the haze sprayer according to the present invention has a configuration of mounting a pump at the center of the frame.

The pump is disposed to drive with power of an engine together with the air blower, and a clutch means for switching power is disposed between the air blower and the pump. Accordingly, a power transmission may be controlled to randomly select a usage timing of the pump.

The clutch means should be able to be remotely operated by an operator with a clutch lever that is extended to the side of the frame, and a manipulation position of the clutch lever is preserved by a lever guide.

The clutch means includes a friction plate that is fixed to an air blower shaft, a hollow shaft having a delivery plate to be moved in an axial direction to a corresponding pump shaft, a movable cam that interlocks with the clutch lever, a fixed cam corresponding to the movable cam and that is integrally formed in the frame, and a bearing that is interposed between the hollow shaft and the movable cam.

In another exemplary embodiment, the clutch means may attaches and fixes an N pole magnet to the friction plate, attaches and fixes an S pole magnet to the delivery plate, and interposes a spring therebetween, thereby being opposite to each other apart a predetermined interval at normal times expert from the power transmission therebetween.

In another exemplary embodiment, the clutch means connects each of a pumping wheel and a turbine wheel that are opposite to each other within a fluid housing in which an oil is filled and connects each of them to the air blower shaft and the pump shaft, and may have a band brake that interlocks with the clutch lever with respect to the pump shaft to brake it.

In another exemplary embodiment, the clutch means is composed such that a bolt head having a first and second screw at both sides is interposed between the air blower shaft and the pump shaft, a first nut and a second nut each connected to the first and the second bolt is attached to the eacn end portion of the the air blower shaft and the pump shaft, accordingly a power transmission may be achieved between the first and second nut and between the first bolt and the second bolt.

In addition, in the chemical container, a plurality of vertical groove is integrally formed in a side surface thereof and thus a diaphragm is protruded to the inside thereof, thereby preventing shaking of the stored chemicals.

Further, a pipe connector that is provided at an upside of the chemical container may be provided with a small diameter pipe supported by a plurality of spacers in an internal passage thereof.

In the haze sprayer according to the present invention, a blade assembly that is disposed at the injection pipe has a configuration in which a central boss of the blades is disposed for the pair of blades to be rotated opposite to each other while sustaining a predetermined interval coaxially by a bushing.

### BRIEF DESCRIPTION OF THE DRAWINGS

FIG. 1 is a perspective view illustrating an entire configuration of a portable haze sprayer according to an exemplary embodiment of the present invention.

FIG. 2 is a cross-sectional view illustrating an internal structure of a chemical container that is shown in FIG. 1.

FIG. 3 is a side cross-sectional view illustrating a pipe connector structure of a chemical container that is shown in FIG. 1.

FIG. 4 is a partial perspective view illustrating a pipe connection structure between a reducer, an extension pipe, and an injection pipe that is shown in FIG. 1.

FIG. 5 is a side cross-sectional view illustrating a structure that is related to a blade assembly of an injection pipe that is shown in FIG. 1.

FIG. 6 is a cross-sectional view illustrating a structure of an elbow that is shown in FIG. 1.

FIG. 7 is a plan view illustrating an exemplary embodiment of a clutch means that is disposed between a pump and an air blower that is shown in FIG. 1.

FIG. 8 is a perspective view illustrating a conversion state of a haze sprayer according to an exemplary embodiment of the present invention when using a pump.

FIG. 9 is a plan view illustrating another exemplary embodiment of the clutch means that is shown in FIG. 7.

FIG. 10 is a plan view illustrating another exemplary embodiment of the clutch means that is shown in FIG. 7.

FIG. 11 is a cross-sectional view illustrating a brake structure of the clutch means that is shown in FIG. 10.

FIG. 12 is a cross-sectional view illustrating another embodiment of the clutch means shown in FIG. 7.

FIG. 13 is a perspective view illustrating an example of mounting and using a portable haze sprayer according to an exemplary embodiment of the present invention in a cart.

FIG. 14 is a perspective view illustrating a conventional haze sprayer.

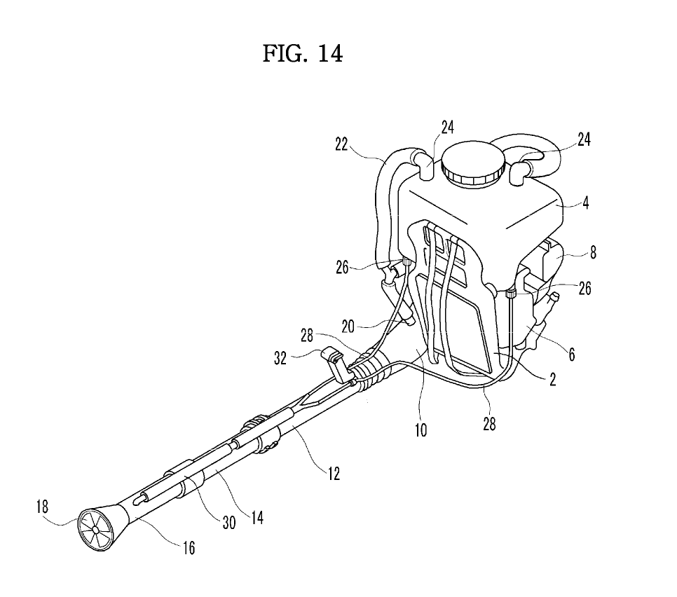

### DETAILED DESCRIPTION OF THE EMBODIMENTS

Hereinafter, preferred exemplary embodiments of the present invention will be described in detail with reference to the attached drawings.

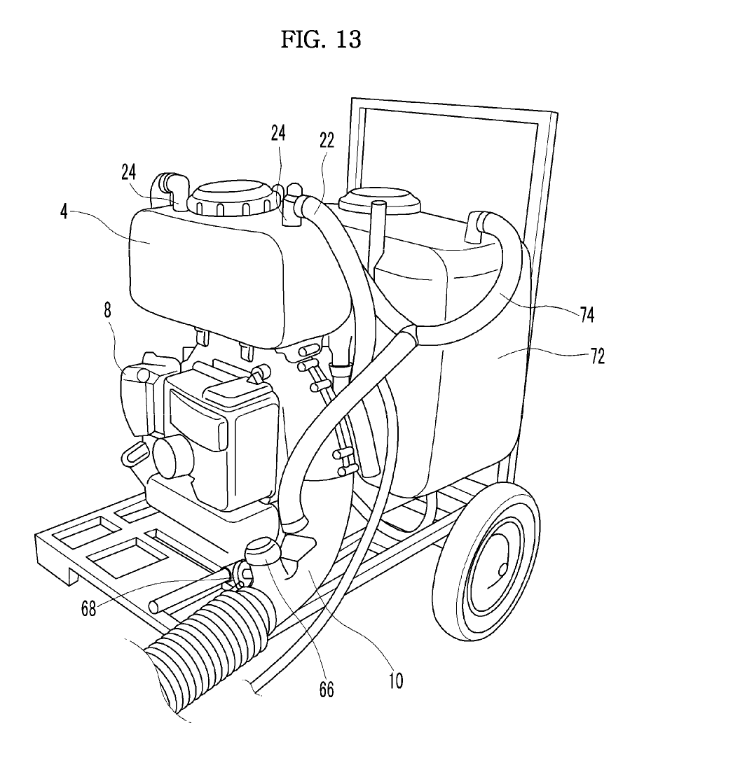

In a portable haze sprayer having a multi-function according to an exemplary embodiment of the present invention, the same elements as those of a conventional haze sprayer of FIG. 13 are denoted by the same reference numerals and thus descriptions thereof will be omitted.

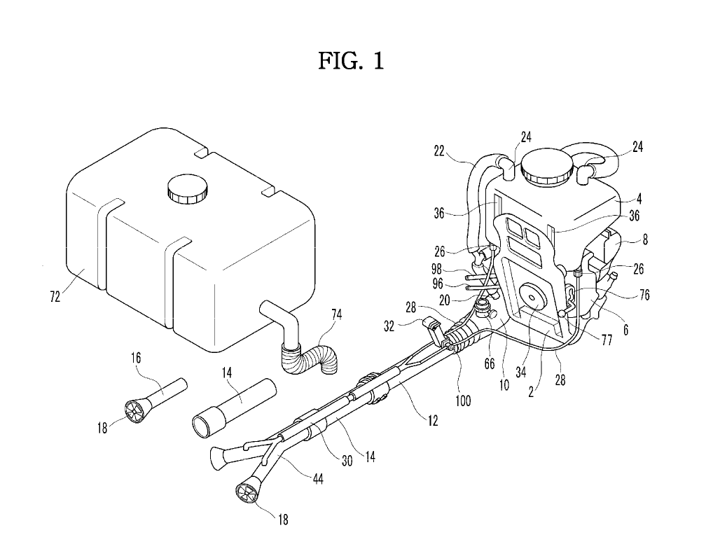

In FIG. 1, in a frame 2, a chemical container 4, an air blower 6, and an engine 8 are mounted at a predetermined position in an assembled state.

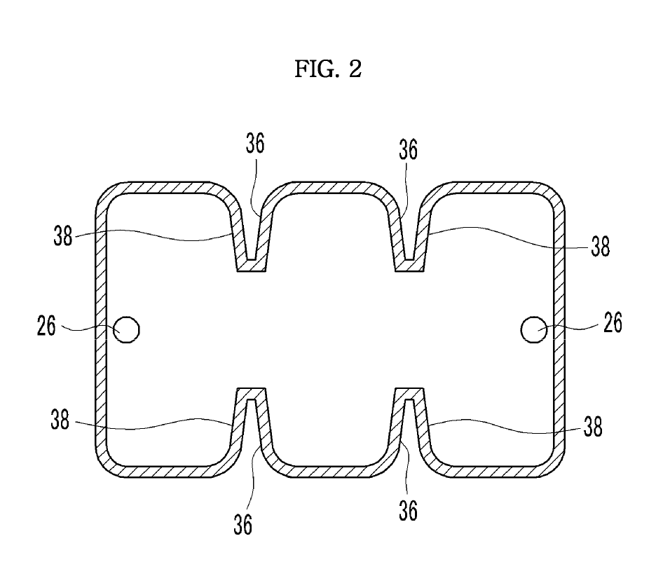

A pump 34 is mounted at the center of the frame 2, a back (not shown) is provided thereon, and a shoulder strap is attached thereto. The chemical container 4 has a plurality of vertical groove 36 is integrally formed in a side surface thereof, these groove 36 are protruded to the inside thereof to form a diaphragm 38 thereby preventing shaking of the stored chemicals as shown in FIG. 2.

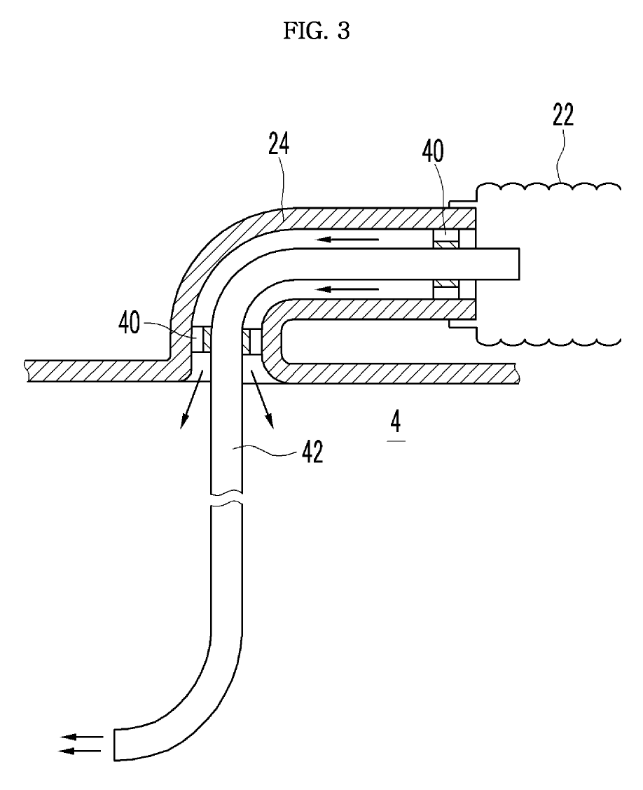

Further, as shown in FIG. 3, a pipe connector 24 has a plurality of spacers 40 on an internal passage, and a small diameter pipe 42 is supported to the center of the spacer 40 to be extended to the bottom of the chemical container 4. By such a structure, as indicated by arrows in the figure, a part of a wind pressure that is supplied from an air supply hose 22 of the air supplying pipe to the pipe connector 24 mixes stored chemicals while being ejected to the bottom of the chemical container 4 through the small diameter pipe 42, thereby changing the stored chemicals to a bubble, and another part thereof pressurizes the upside of chemicals though a clearance formed by the spacer 40, thereby the stored chemicals are pushed out to an end pipe 30 through a chemical hose 28.

The above-described structure can be manufactured in a method of injection molding the spacer 40 and the small diameter pipe 42 with a resin having a high melting point, inserting the spacer 40 and the small diameter pipe 42 into a blower mold, and blower molding the entire chemical container 4 including the pipe connector 24 with a resin having a low melting point.

In this exemplary embodiment, a Y type injection pipe 44 that is divided into two is connected to the end pipe 30, however can be replaced into a linear type injection pipe 16 and has a blade assembly 18 at the front thereof. Further, another extension pipe 14 may additionally be provided to the end pipe 30, Y type injection pipe 44, or the linear type injection pipe 16, thereby to spraying to a far distance.

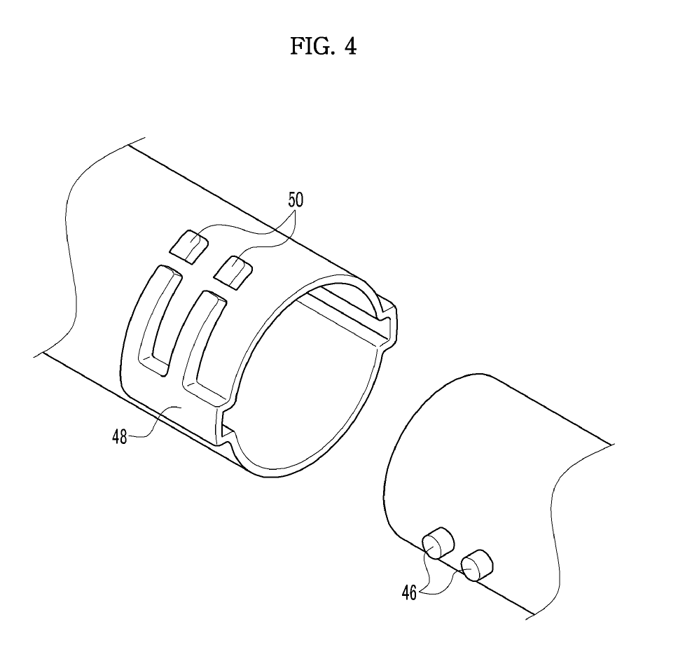

However, in order for the extension pipe 14, the injection pipe 16, and the Y type injection pipe 44 to be simply and firmly connected to each other, as shown in FIG. 4, protrusions 46 are formed in parallel in pairs in one pipe, a right-angled channel 48 in which the protrusion 46 is inserted and slid is protruded in the corresponding pipe, and a protruded groove 50 is formed to correspond to the protrusion 46 and apart some interval from the right-angled channel 48. When the both protrusions 46 are inserted into the right-angled channel 48, moved in an axial direction thereof, and then rotated in a circumferential direction thereof, the position of the both protrusions 46 is fixed in the protruded groove 50, thereby two pipes may be firmly connected to each other or may be simply disconnected from each other.

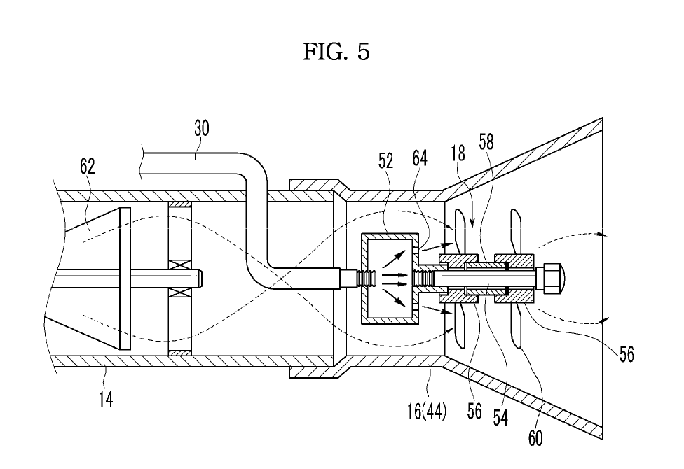

The blade assembly 18 that is provided in the injection pipe 16 or the Y type injection pipe 44 has a nozzle 52 that is communicated to the end pipe 30, as shown in FIG. 5, and a pair of bosses 56 is coaxially disposed to a shaft 54 that is extended to the front from the center of the nozzle 52 while sustaining an interval by a bushing 58 and rotatably supports two blades 60.

As in a prior art, a vortex generation blade 62 is rotatably provided within the extension pipe 14, and a wind pressure that is supplied through the reducer 12 becomes a vortex and is supplied to the injection pipe 16 or the Y type injection pipe 44.

In FIG. 5, a vortex that is generated by the vortex generation blade 62 is indicated by dotted line arrows, and bubble-shaped chemicals that are supplied to the nozzle 52 through the end pipe 30 are indicated by solid line arrows.

The bubble-shaped chemicals that are supplied to the nozzle 52 are sprayed toward the blade 60 from a nozzle hole 64 and become the haze by splitting with a vortex. A pair of blades 60 rotates in a high speed by a vortex, becomes the haze by splitting with a vortex. The first hazed chemicals are secondary split into a small particle and become the haze again by colliding several times with a surface of the blade 60 while passing through the blade 60 rotating in a high speeds, the haze sprayer according to an exemplary embodiment of the present invention sprays chemicals of ultra-fine particles that cannot be obtained in a conventional haze sprayer.

In the haze sprayer that is shown in FIG. 1, a powder supply pipe 66 is provided at one end of the elbow 10 that is communicated between the air blower 6 and the reducer 12 and is opened or closed in an internal passage by an external handle 68.

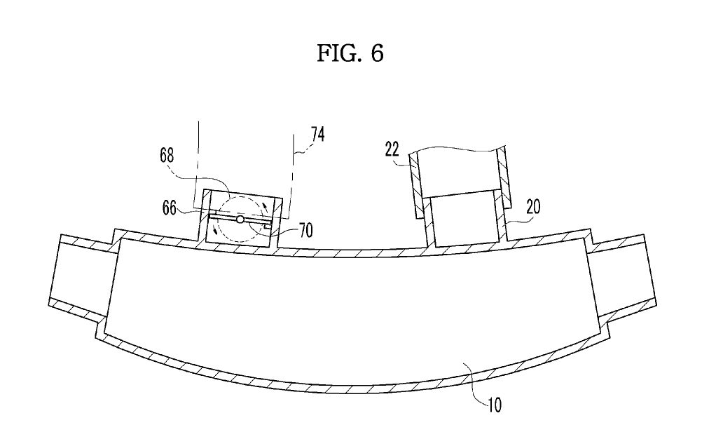

That is, as shown in FIG. 6, the powder supply pipe 66 has a valve 70 in an internal passage, and the valve 70 is interlocked with the handle 68 to be opened or closed. Further, a supply hose 74 of a storage container 72(see FIG.1) that is separately provided only when using is connected to the powder supply pipe 66, thereby granular fertilizer and powder chemicals, or the like are supplied into the elbow 10. The supplied granular fertilizer and powder chemicals are supplied to the reducer 12 through the powder supply pipe 66, and are sprayed from the injection pipe 16 or the Y type injection pipe 44 like liquid chemicals.

The granular fertilizer and the powder chemicals may be sprayed with only itself or together with liquid chemicals that are hazed and sprayed according to a situation, and the haze sprayer can be simply carried by separating the supply hose 74 from the powder supply pipe 66 when un-using.

In the haze sprayer that is shown in FIG. 1, the pump 34 that is mounted in the frame 2 is used for spraying chemicals that are stored in the chemical container 4 to a high branch of such as fruit tree, a street tree, or a deep sinkhole.

The pump 34 may be provided such that it is driven by the engine 8, however, it may be preferably provided with the clutch means capable of controlling a power transmission system of the engine. In order to remotely controlling the clutch means, a clutch lever may be provided at one side of the frame, which switches power transmission to the air blower 6 according to a position of a clutch lever 77 in a lever guide 76.

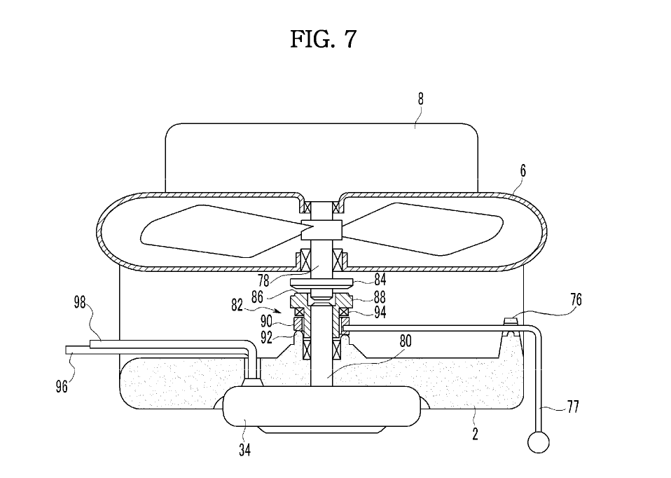

Referring to FIG. 7, a clutch mean according to one embodiment is configured such that an air blower shaft 78 and a pump shaft 80 are concentrically disposed, and a clutch means 82 is connected therebetween.

The clutch means 82 includes a friction plate 84 for integrally rotating with the air blower shaft 78, a delivery plate 86 corresponding to the friction plate 84, a hollow shaft 88 that has a delivery plate 86 corresponding to the friction plate 84 and that is disposed to be moved in a axial direction from the pump shaft 80, a ring-shaped movable cam 90 that is integrally connected to the clutch lever 77, a fixed cam 92 that is opposite to the movable cam 90 in the frame 2, and a bearing 94 that is interposed between the hollow shaft 88 and the movable cam 90.

The movable cam 90 and the fixed cam 92 is a ring-shaped swash plate cam having a incline plane symmetric to each other, the hollow shaft 88 is connected to the pump shaft 80 to integrally rotate, however is supported to freely rotate with the air blower shaft 78.

The clutch means 82 having the above-described configuration enables the delivery plate 86 of the hollow shaft 88 to come in strong contact with the friction plate 84 or to be positioned apart an interval from the friction plate 84 between the air blower shaft 78 and the pump shaft 80 as the user manipulates the clutch lever 77, thereby switching power transmission.

As the clutch lever 77 is positioned at an upside or a downside along the lever guide 76, the hollow shaft 88 moves in an axial direction by a cam operation generating on a surface coming in contact with the fixed cam 92 while the movable cam 90 rotates, whereby the operation of the clutch means 82 is appeared.

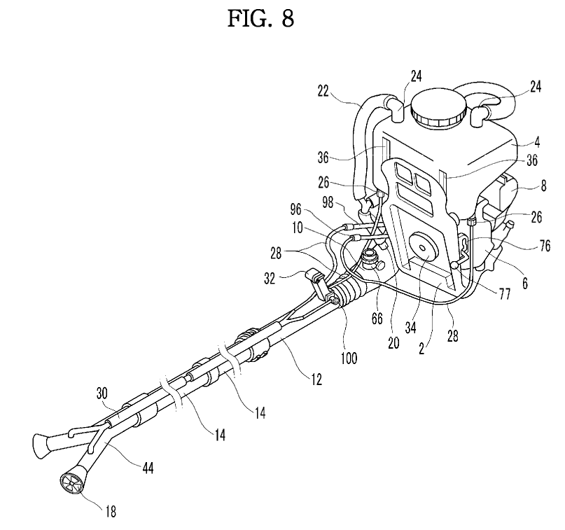

When spraying chemicals through the pump 34, as shown in FIG. 8, one chemical hose 28 expanded from one supply pipe 26 of the chemical container 4 to valve 100, is separated from the valve 100, is connected to the inlet 96, and the other chemical hose 28 extended between the valve 100 and the end pipe 30 is separated from the valve 100, and is connected to the outlet 98 of the pump 34 is communicated to one chemical hose 28, and the other supply pipe 26 and chemical hose 28 close a valve 100 that is provided at both sides of the control lever 32, thereby operating without affecting an operation of the pump 34.

At normal times that do not use the pump 34, as shown in FIG. 1, an inlet 96 and an outlet 98 of the pump 34 sustain an open state.

Further, when spraying chemicals through the pump 34, as shown in FIG. 8, only one supply pipe 26 of the chemical container 4 is connected to the inlet 96 and the outlet 98 of the pump 34 is communicated to one chemical hose 28, and the other supply pipe 26 and chemical hose 28 close a valve 100 that is provided at both sides of the control lever 32, thereby operating without affecting an operation of the pump 34.

Because the spray using the pump 34 can transfer chemicals to a far distance of more than 20-30 meters, when at least two extension pipes 14 are added, the injection pipe 16 or the Y type injection pipe 44 may be further extended to spray the chemicals.

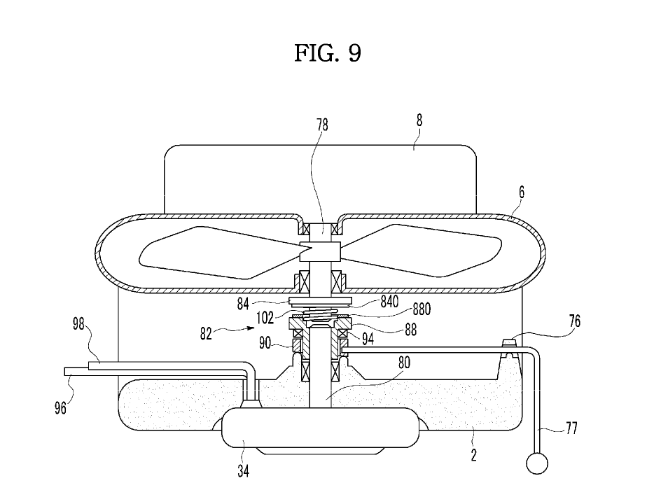

The clutch means 82 is not limited to a configuration that is shown in FIG. 7, FIG. 9 is another exemplary embodiment of a clutch mean according to the present invention, wherein the clutch means 82 attaches and fixes each of an N pole magnet 840 and an S pole magnet 880 to a surface in which the friction plate 84 and the hollow shaft 88 are opposite to each other and the spring 102 is interposed therebetween.

When the hollow shaft 88 is pushed in an axial direction while resisting to the spring 102 by a manipulation of by the movable cam 90 interlocked with the clutch lever 77, the S pole magnet 880 approaches the N pole magnet 840 of the friction plate 84 and thus both magnets 840 and 880 becomes one body by a magnetic force, thereby becoming a power connection state. When the hollow shaft 88 is released in a free state, an elastic force of the spring 102 is operated to separate the both magnets 840 and 880 from each other, thereby becoming a power interception state and performing a clutch operation.

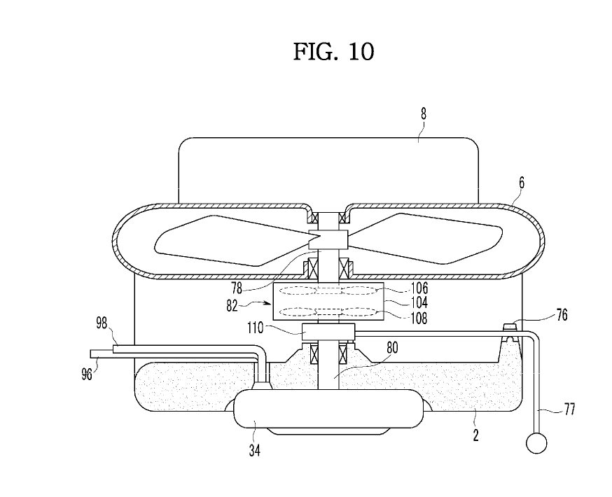

Further, the clutch means 82 having a structure of FIG. 10 may be applied to the haze sprayer according to an exemplary embodiment of the present invention.

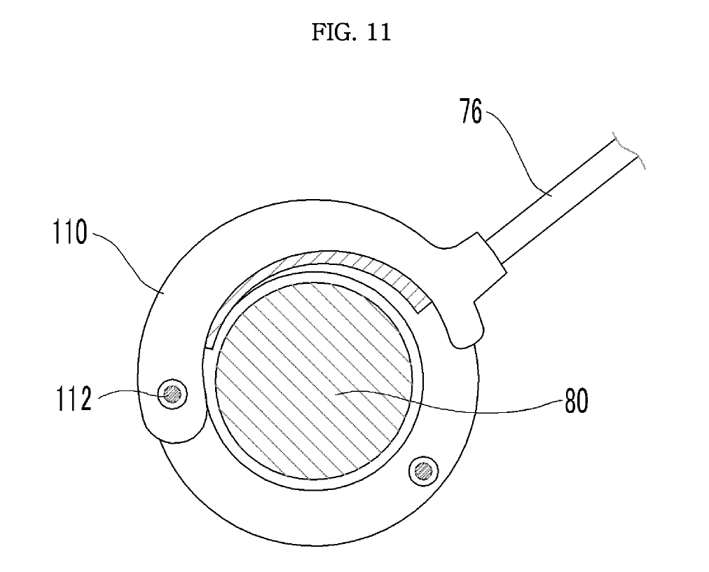

In this exemplary embodiment, the clutch means 82 includes a fluid housing 104 that is interposed between the air blower shaft 78 and the pump shaft 80, a fluid clutch in which a pumping wheel 106 that is fixed to the air blower shaft 78 and a turbine wheel 108 that is fixed to the pump shaft 80 are disposed to be opposite to each other is provided within the fluid housing 104, and the clutch lever 77 is attached to the frame 2 to operate a band brake 110 for braking the pump shaft 80. In addition, as shown in FIG. 11, the band brake 110 may be simply realized such that it controls the pump shaft 80 by being interworked and rotated with the clutch lever 77 based on the stub shaft 112 at which the frame 2 is fixed.

In the clutch means 82 having the above-described configuration, because the pumping wheel 106 that is fixed to the air blower shaft 78 always rotates by the engine 8, an oil that is stored in the fluid housing 104 simultaneously performs the whirling flow and the rotation flow, thereby causing a centrifugal force, and the centrifugal force operates an opposite turbine wheel 108, thereby causing the following rotation.

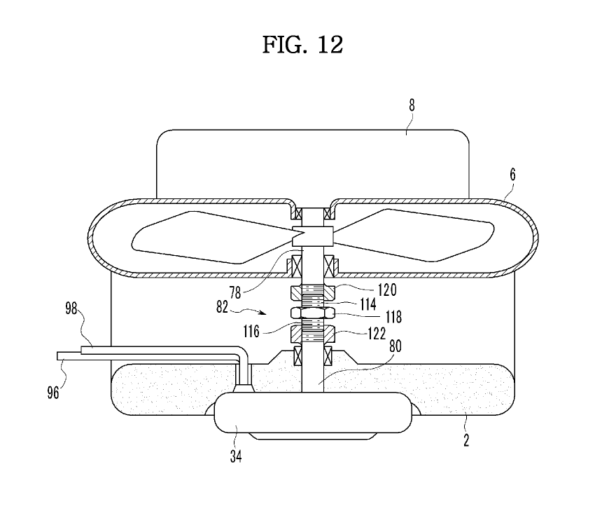

FIG. 12 is another embodiment of the clutch mean according to the present invention.

The clutch mean is configured such that a turn buckle 11 8 is interposed between the air blower shaft 78 and the pump shaft 80, in which a first and second screw 114 and 116 are expanded at both sides thereof and a first and second nut 120 and 122 are each screwed to each of the first and second screw 114 and 116 at the end portion of the air blower shaft 78 and the pump shaft 80.

In such a structure, the first and second screw 114 and 116 are positioned in the same direction and the first screw 114(the second screw 116)is screwed with the first nut 120(the second nut 122) in a further distance, the second screw 116(the first screw 114) is separated from the second nut 122(the first nut 120), thereby the power is not transmitted.

According to such a structure, because the first and second screw 114 and 116 are always positioned in the same direction, when the turn buckle 118 is rotated in a locked direction in a state in which the engine 8 is not driven, the first screw 114is screwed with the first nut 120 by the length through which the second screw 116 is loosed from the second nut 122, thereby the first screw 114 connects the air blower shaft 78 and the pump shaft 80 to be converted into the power transmission state. The clutch means 82 simply realizes the object of the present invention.

The haze sprayer according to an exemplary embodiment of the present invention may be executed in a form that is shown in FIG. 13.

FIG. 13 shows an example where the haze sprayer is mounted at a hand cart, a power cart, etc. and used. In this case, the elbow 10 that is communicated to the air blower 6 can be used by converting a direction by 180°, as needed, and a configuration having both the chemical container 4 and a large chemical container may be used.

In a haze sprayer according to an exemplary embodiment of the present invention having the above-described configuration, because an elbow that is communicated to an output terminal of an air blower further includes a powder supply pipe that is opened or closed by a valve, the haze spray can spray powder chemicals through an injection pipe.

Further, because a pump switched by the clutch means is mounted at the center of the frame, chemicals that are stored in the chemical container can be transferred to a far distance with a high pressure, whereby the chemicals can be sprayed to the top of a fruit tree or a street tree, or a deep sinkhole.

Further, because a clutch means can switch power transmission between the air blower and the pump, the pump can be simply used only in a necessary case.

Further, because the chemical container has a plurality deep grooves at an external side surface and a diaphragm that is integrally formed at the inside thereof, a process of assembling the diaphragm may be omitted and a lid or neck size of the chemical container can be reduced, thereby reducing a mold cost.

A dual structure of a spacer and a small diameter pipe that can be formed in a pipe connector of the chemical container has both an effect of making chemicals in a bubble state as a wind pressure that is supplied through the small diameter pipe mixes the chemicals and a chemical supply effect of pushing out chemicals in a bubble state through a supply pipe with a wind pressure that is supplied through an interval formed by the spacer.

In the haze sprayer according to the present invention, because a blade assembly that is applied to the injection pipe has a configuration in which two blades are coaxially arranged, a chemical particle is collided with a rotating blade thereby further performing a hazing process to spray ultra-fine particles.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A portable haze sprayer comprising:
a chemical container provided with a pipe connector for supplying a wind pressure from outside and a supply pipe to be an exit of stored liquid chemicals;
an air blower to be driven by an engine;
a frame for supporting the chemical container, the engine, and the air blower;
an elbow that is communicated to an output terminal of the air blower and supplying a wind pressure to the pipe connector of the chemical container through an air supply pipe; and
a spray pipe that is interposed to the elbow and a reducer and provided with a blade assembly for hazing chemicals therein, and
a powder supply pipe that is opened or closed by a valve which is provided at one end of the elbow, the valve having a handle.

2. A portable haze sprayer comprising:
a chemical container provided with a pipe connector for supplying a wind pressure from outside, a supply pipe to be an exit of stored liquid chemicals, and containing liquid chemicals therein;
an air blower to be driven by an engine;
a frame for supporting the chemical container, the engine, and the air blower;
an elbow that is communicated to an output terminal of the air blower and supplying a wind pressure to the pipe connector of the chemical container through an air supply pipe;
a pump disposed opposite to the air blower in a center of the frame,
a spray pipe that is interposed to the elbow and a reducer and provided with a blade assembly for hazing chemicals therein, and
a clutch mean for switching a power transmission series of between the air blower and the pump.

3. The portable haze sprayer of claim 2, wherein the clutch means comprises a friction plate that is integrally fixed to an air blower shaft, a hollow shaft that is disposed to be moved in an axial direction to a pump shaft and that has a delivery plate corresponding to the friction plate at one side, a lever guide disposed at the frame, a clutch lever to be moved according to the lever guide, a movable cam that interlocks with the clutch lever, a fixed cam that corresponds to the movable cam to be integrally formed in the frame, and a bearing that is interposed between the hollow shaft and the movable cam.

4. The portable haze sprayer of claim 2, wherein the clutch means comprises a friction plate that is integrally fixed to an air blower shaft and that has an N pole magnet,
a hollow shaft that is disposed to be moved in an axial direction to a pump shaft and in which an S pole magnet is attached to a surface corresponding to the friction plate,
a spring that is interposed between the friction plate and the hollow shaft,
a movable cam that interlocks with the clutch lever,
a fixed cam that corresponds to the movable cam to be integrally formed in the frame, and
a bearing that is interposed between the hollow shaft and the movable cam.

5. The portable haze sprayer of claim 2, wherein the clutch means comprises a pumping wheel that is fixed to an air blower shaft,
a turbine wheel that is fixed to a pump shaft,
a fluid housing for separating the pumping wheel and the turbine wheel from the outside and for housing an oil,
and a band brake that interlocks with the clutch lever to brake the pump shaft.

6. The portable haze sprayer of claim 2, wherein the clutch means comprises a turn buckle extended from a first and second screw, a first nut attached to the air blower shaft in correspondence to the first screw, and a second nut attached to the air blower shaft in correspondence to the second screw.

7. The portable haze sprayer of claim 2, wherein the chemical container integrally comprises a diaphragm that is protruded to the inside thereof by a plurality of vertical grooves that are formed at a side surface.

8. The portable haze sprayer of claim 2, wherein the pipe connector of the chemical container is supported by a plurality of spacers in an internal passage.

9. A portable haze sprayer comprising:
a chemical container comprising a pipe connector for supplying a wind pressure and a supply pipe to be an exit of stored liquid chemicals;
an air blower to be driven with an engine;
a frame for supporting the chemical container, the engine, and the air blower;
an elbow that is communicated to an output terminal of the air blower to supply a wind pressure to the pipe connector of the chemical container through an air supply pipe;
a spray pipe that is communicated to the elbow and in which a blade assembly for hazing chemicals that are supplied from the chemical container is provided at the inside thereof;
a powder supply pipe that is provided at a side of the elbow to spray a granular fertilizer or powder chemicals to the injection pipe to be opened or closed with a valve with a handle;
a pump that is mounted at the center of the frame;
a clutch means that is disposed between the air blower and the pump and that interlocks with a clutch lever to switch power; and
a level guide for guiding the clutch lever,
wherein the blade assembly of the injection pipe comprises a pair of bosses that is disposed to sustain a predetermined interval by a bushing and that rotatably supports a blade.
